(19) United States
(12) Patent Application Publication
(10) Pub. No.: US 2007/0052619 A1
(43) Pub. Date: Mar. 8, 2007

(54) Color display apparatus using two panels

(75) Inventors: In-Jae Yeo, Yongin-si (KR); Sang-Kyeong Yun, Suwon-si (KR); Kyu-Bum Han, Suwon-si (KR); Seung-Won Ryu, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/517,739

(22) Filed: Sep. 7, 2006

(30) Foreign Application Priority Data
Aug. 17, 2006 (KR) 10-2006-0077533
Sep. 7, 2005 (KR) 10-2005-0083002

(51) Int. Cl. G09G 3/00

(52) U.S. Cl. 345/30

(57) ABSTRACT

A two panel type color display device is disclosed, comprising a buffer memory storing RGB information corresponding to one frame—herein, the RGB information contains the intensity of red, green, and blue colors of (the number of vertical line pixels)×(the number of horizontal line pixels) pixels constituting one frame—; an image processor accessing the RGB information stored in the buffer memory and extracting therefrom fixed color image information corresponding to a fixed color light and a plurality of variable color image information corresponding to a plurality of variable color lights; a color-fixed panel modulating the fixed color light according to the fixed color image information and outputting the modulated fixed color light; a color-variable panel modulating the corresponding variable color lights according to the plurality of variable color image information and outputting the modulated variable color lights sequentially; a fixed color light source providing the fixed color light to the color-fixed panel; a plurality of variable color light sources providing the variable color lights to the color-variable panel; a color synthesizing part generating a synthesized signal combined the modulated fixed and variable color lights; and a projection part scanning the synthesized signal in a predetermined direction on a screen.

### BACKGROUND

1. Technical Field

The present invention relates to a color display device, in particular, to a color display device using two panels each comprising an optical modulator element, diffracted lights generated by each panel which are combined in a time-division manner to implement a color image.

2. Description of the Related Art

As display technologies have advanced, the demand on large screen display devices has grown. The majority of current large screen display devices (mainly projectors) are using liquid crystals as a light-switcher. Such a liquid crystal projector has been popular due to the fact that it is smaller, cheaper, and has a simpler optical system than a CRT projector. However, in the liquid crystal projector, large amount of light is lost since the light is projected to a screen by passing through a liquid crystal panel. A micro-machine such as an optical modulator element using reflection is employed to reduce such light loss, by which brighter images are obtained.

The micro-machine refers to a miniature machine indiscernible with the naked eye. It can also be called a micro electro mechanical system (MEMS), and mainly fabricated by semiconductor manufacturing technology. These micro-machines are applied in information devices such as a magnetic and optical head by using micro-optics and limitation elements, and also applied in the biomedical field and the semiconductor manufacturing process by using various micro-fluidics. The micro-machines can be divided based on their function into a micro-sensor, a micro-actuator and a miniature machine delivering energy.

The MEMS can also be applied in optics. Using MEMS technology, optical components smaller than 1 mm can be fabricated, by which micro optical systems can be implemented.

Micro optical components belonging to the micro-miniature optical system such as an optical modulator element, a micro-lens, and the like are applied in telecommunication devices, display devices and recording devices, due to such advantages as quick response time, low level of loss, and convenience in layering and digitalizing.

FIG. 1 shows a conventional single panel type color display device employing an optical modulator element in which a MEMS element is applied

Referring to FIG. 1, the conventional single panel type color display device comprises a light source part 110, a light concentrating part 115, an illumination lens part 120, a plate type color wheel 125, an optical modulator element 130, a fourier filter part 150, a projection system 160, and a screen 170.

The light source part 110 has a plurality of light sources, each consisting of three primary colors, a red light source 111, a green light source 112, and a blue light source 113. The light concentrating part 115 consists of a mirror 116 and a plurality of sectional mirrors 117 and 118 by which the red, green and blue lights are concentrated to generate a multiple beam, thereby forming a single illumination system.

The illumination lens part 120 changes such condensed multiple light beam to a linear parallel light, and then provides the linear parallel light through the plate type color wheel 125 to the optical modulator element 130. The plate type color wheel 125 separates red, green, and blue light sequentially from the linear parallel light.

The optical modulator element 130, constituting a panel, forms a diffracted light by modulating the light from the plate type color wheel 125, and provides the diffracted light to the fourier filter part 150.

The fourier filter part 150 consists of a fourier lens 152 and a space filter 154, and sorts the diffracted light beams according to the order, followed by filtering the diffracted light of desired order.

The projection system 160 comprises a scanner 162 and a projection lens 164, and projects the incident diffracted light onto the screen 170.

FIG. 2 shows a conventional three panel type color display device using an optical element in which a MEMS element is applied.

The conventional three-panel type color display device comprises a light source part 210, an illumination part 220, three panels 230, a color synthesizing part 250, a projection system 260 and a screen 270.

The light source part 210 consists of a plurality of laser light sources, each consisting of a red light source 212, a green light source 214, and a blue light source 216, which are the three primary colors of light. Each color light of the light source part 210 is incident via beam forming lenses 220a and 220b of the illumination part 220 to each panel 230.

The three panels 230 each have one optical modulator elements 232, 234, and 236. The optical modulator elements 232, 234, and 236 modulate the intensity of the incident color lights (red, green, and blue lights), and the modulated lights are later projected to the color synthesizing part 250.

A color-synthesizing filter 252 in the color synthesizing part 250 combines the intensity-modulated red, green and blue lights, from the synthesized product of which only signal components are extracted by the space filter 254.

The signal components are scanned to the space by a scanner 262 (FIG. 2 shows a galvano mirror as an example) of the projection system 260 synchronizing with image signals, and projected on the screen 270 as a color image by the projection lens 264.

The conventional single panel type color display device, described above, can have a simple structure and a simple optical system. However, it has such disadvantages that the optical modulator should operate with treble speed, whereby its life span is shortened to one third. Moreover, because the color wheel is used to separate each color light from the multiple beam, the single panel type color display device has a low light-efficiency.

The conventional three-panel type color display device should have three optical modulator elements corresponding to the three laser light sources, causing the optical system to be complicated and the manufacturing cost to increase. Furthermore, in case that the power of one of the laser light sources is weak, image quality deteriorates.

### SUMMARY

Accordingly, the present invention aims to provide a two panel type color display device requiring smaller electric power of light source than a single panel type.

Also, the present invention aims to provide a two panel type color display device of which a fixed color light source requires half as much optical power as a variable color light source, thereby capable of using a light source having a relatively low optical power as a fixed color light source.

Also, the present invention aims to provide a two panel type color display device having less panels than a three panel type display device, by which the optical system and the circuits are simplified, to considerably reduce the overall material cost.

One aspect of the invention provides a two panel type color display device comprising: a buffer memory storing RGB information corresponding to one frame—herein, the RGB information contains the intensity of red, green, and blue colors of (the number of vertical line pixels)×(the number of horizontal line pixels) pixels constituting one frame—; an image processor accessing the RGB information stored in the buffer memory and extracting therefrom fixed color image information corresponding to a fixed color light and a plurality of variable color image information corresponding to a plurality of variable color lights; a color-fixed panel modulating the fixed color light according to the fixed color image information and outputting the modulated fixed color light; a color-variable panel modulating the corresponding variable color lights according to the plurality of variable color image information and outputting the modulated variable color lights sequentially; a fixed color light source providing the fixed color light to the color-fixed panel; a plurality of variable color light sources providing the variable color lights to the color-variable panel; a color synthesizing part generating a synthesized signal combined the modulated fixed and variable color lights; and a projection part scanning the synthesized signal in a predetermined direction on a screen.

Here, the color-fixed and color-variable panels each comprise an optical modulator element outputting a diffracted light generated by modulating incident light according to control signals, wherein the control signals are the fixed color and variable color image information, and the incident light consists of the fixed and variable color lights, and the diffracted light consists of the modulated fixed and variable color lights.

Also, the fixed color image information, the variable color image information, and the synthesized signal represent one vertical line that is one dimensional image displayed on the screen, and are implemented as a two dimensional image by being scanned in a horizontal direction in the projection part.

Also, the fixed color image information, the variable color image information, the synthesized signal represent one horizontal line that is one dimensional image displayed on the screen, and are implemented as a two dimensional image by being scanned in a vertical direction in the projection part.

Also, one of red, green, and blue lights is the fixed color light, and the other two are the variable color lights.

Also, in the case that one of the plurality of variable color light sources is turned on, the rest of the variable color light sources are turned off.

Here, the fixed color image information contains the intensity of the variable color light corresponding to the turned on variable color light source.

Also, the projection part comprises a scanner converting the synthesized signal of one dimensional image to a two dimensional image on the screen.

Here, the scanner is a polygon mirror having a polygonal prism shape, the scan frequency is equal to (2n times the field frequency according to a television broadcasting method (n is a natural number))/(the number of the sides of the polygonal prism), and the scanner is a galvano mirror, and the scan frequency is equal to 2n times the field frequency according to a television broadcasting method (n is a natural number).

Here, the fixed color light source keeps turned on, while the variable color light source is repeatedly turned on or off sequentially according to the scan frequency.

Also, the image processor delivers the fixed color image information to the color fixed panel twice during one frame time, and delivers the plurality of variable color image information to the color variable panel sequentially one by one.

Here, the variable color light source responds to the variable color image information delivered from the image processor, thereby repeatedly turned on or off sequentially.

Additional aspects and advantages of the present invention will be set forth in part in the description which follows and, in part, will be apparent from the description, or may be learned by practice of the invention.

### DESCRIPTION OF THE DRAWINGS

FIG. 1 illustrates an embodiment of a conventional single panel type color display device using an optical modulator in which a MEMS element is applied;

FIG. 2 illustrates an embodiment of a conventional three panel type color display device using an optical modulator in which a MEMS element is applied;

FIGS. 3(a) and 3(b) show the configuration of GLV (grating light valve) device, one of the optical modulators manufactured by the Silicon Light Machine Co., Ltd.;

FIGS. 4(a) and 4(b) show a principle by which incident lights are modulated in the GLV device of the FIGS. 3(a) and 3(b);

FIG. 5A is a perspective view of a diffraction type optical modulator element using piezoelectric elements, one of indirect type optical modulators applicable to the embodiments of the present invention;

FIG. 5B is a perspective view of another diffraction type optical modulators element using piezoelectric elements applicable to the embodiments of the present invention;

FIG. 5C is a plan view of a diffraction type optical modulator array applicable to the embodiments of the present invention;

FIGS. 5D(a) and (b) explain a principle of modulation in a diffraction type optical modulator applicable to the embodiments of the present invention;

FIG. 6 is a diagram showing an image generated on a screen by a diffraction type optical modulator array applicable to the embodiments of the present invention;

FIG. 7 illustrates a schematic configuration of a two panel type color display device according to an embodiment of the present invention;

FIG. 8 illustrates a driving circuit driving a color-fixed panel and a color-variable panel;

FIGS. 9A and 9B show an exemplary image information transmitted from an image processor to each panel with the passage of time in accordance with an embodiment of the present invention; and

FIGS. 10(a) and 10(b) illustrate diverse embodiments of a scanner used in the present invention.

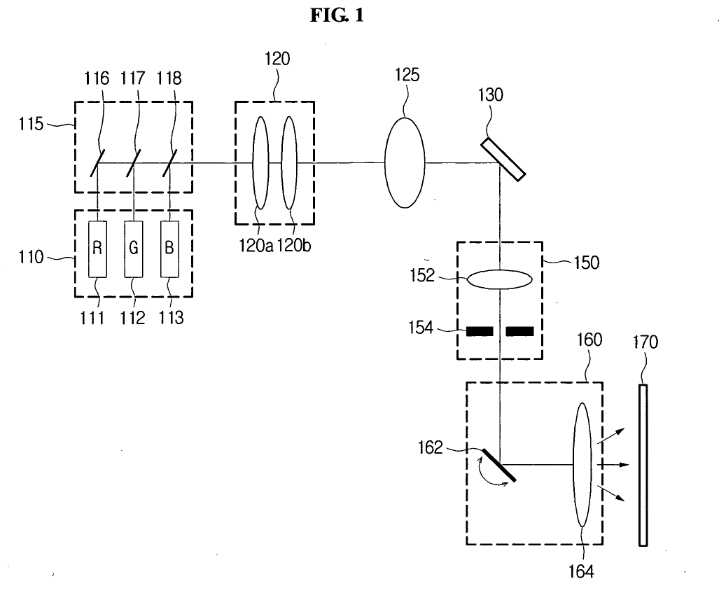

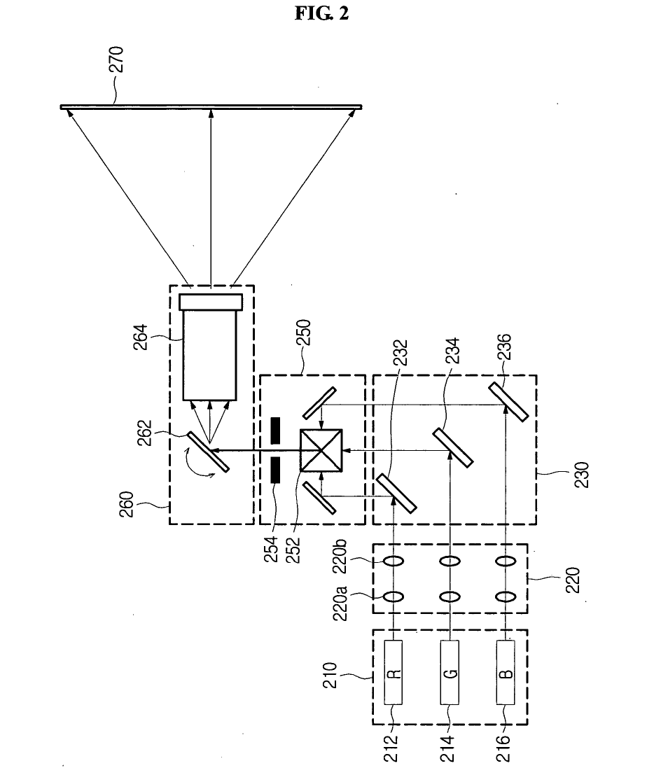

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

Also, an optical modulator applicable to the present invention will first be described before discussing the embodiments.

The optical modulator can be divided mainly into a direct type, which directly controls the on/off state of light, and an indirect type, which uses reflection and diffraction. The indirect type may be further divided into an electrostatic type and a piezoelectric type. Optical modulators are applicable to the embodiments of the present invention regardless of the operation type.

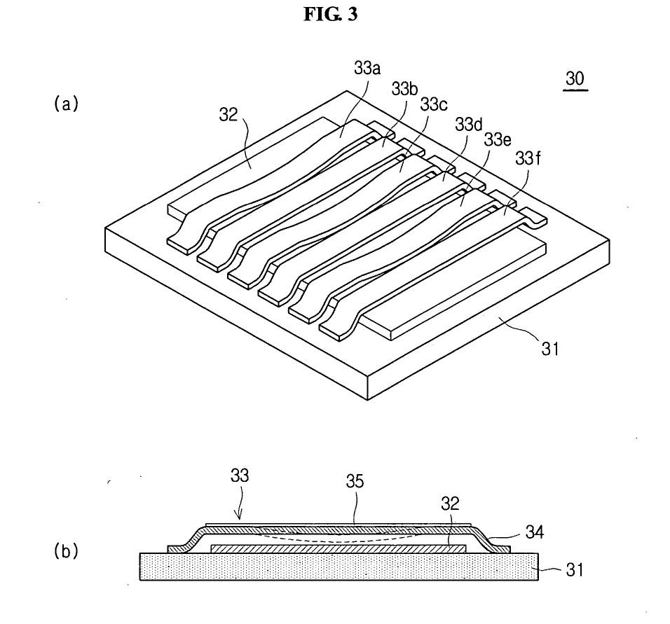

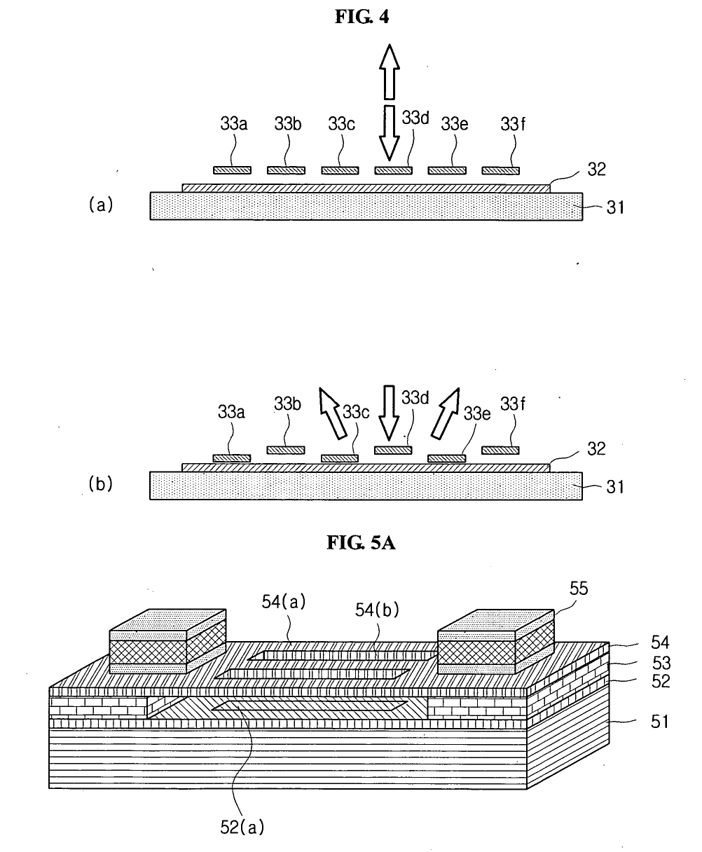

FIGS. 3(a) and 3(b) show the configuration of GLV (grating light valve) device 30, one of the optical modulators manufactured by the Silicon Light Machine Co., Ltd, and FIG. 4 shows a principle by which incident light is modulated in the GLV device 30 of the FIGS. 3(a) and 3(b).

As shown in FIGS. 3(a) and 3(b), the GLV device 30 comprises an insulation substrate 31 such as a glass substrate, a substrate side electrode 32 formed on the insulation substrate 31, and a plurality of beams 33a to 33f, hereinafter abbreviated as 33 (here in this embodiment, the number of the beams is 6), disposed across the substrate side electrode 32 in parallel.

Each beam 33 consists of a bridge part 34 and a drive side electrode 35 formed of aluminum (Al) film and mounted on the bridge part 34 to function also as a reflective film, and both ends of the beam 33 are supported to form a so called bridge type.

The beam 33 gets bent due to attractive or repulsive forces between itself and the substrate side electrode 32 according to electric potential between the substrate side electrode 32 and the drive side electrode 35. As drawn in solid and dotted lines of FIG. 3(b), the beam 33 bends toward the substrate side electrode 32 or returns to the parallel mode.

The plurality of beams 33 are alternatively changed to the parallel or concave modes. In case that the beams 33 are not supplied with power, the beams 33 remain in the parallel mode as shown in FIG. 4(a). When a minute power is supplied to the odd-numbered beams 33a, 33c, and 33e, the odd-numbered beams 33a, 33c, and 33e bend to a concave mode, while the even-numbered beams 33b, 33d, and 33f remain in the parallel mode. In such case, incident light is diffracted (interfered) due to the path difference between a first reflective light reflected by the odd-numbered beams 33a, 33c, and 33e and a second reflective light reflected by the even-numbered beams 33b, 33d, and 33f so that the intensity of the light is modulated. By using that, the gray scale of screen pixels, namely light intensity is represented. It is assumed that the plurality of beams 33 (the number of them is six in this embodiment) represent a single light intensity, and constitute a single micro-mirror.

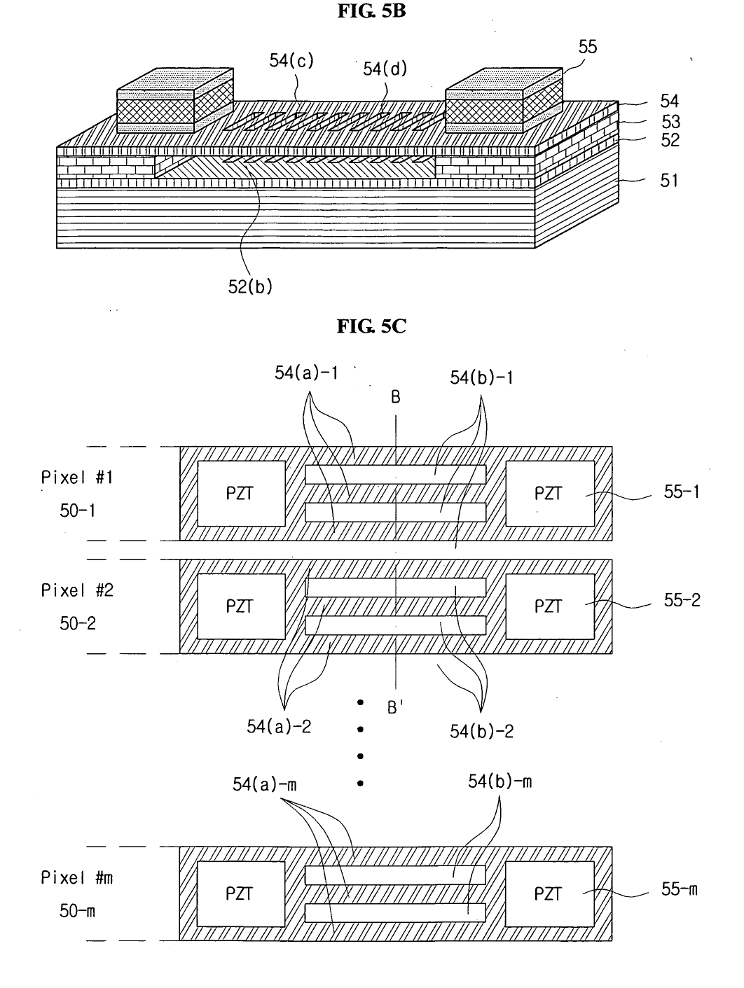

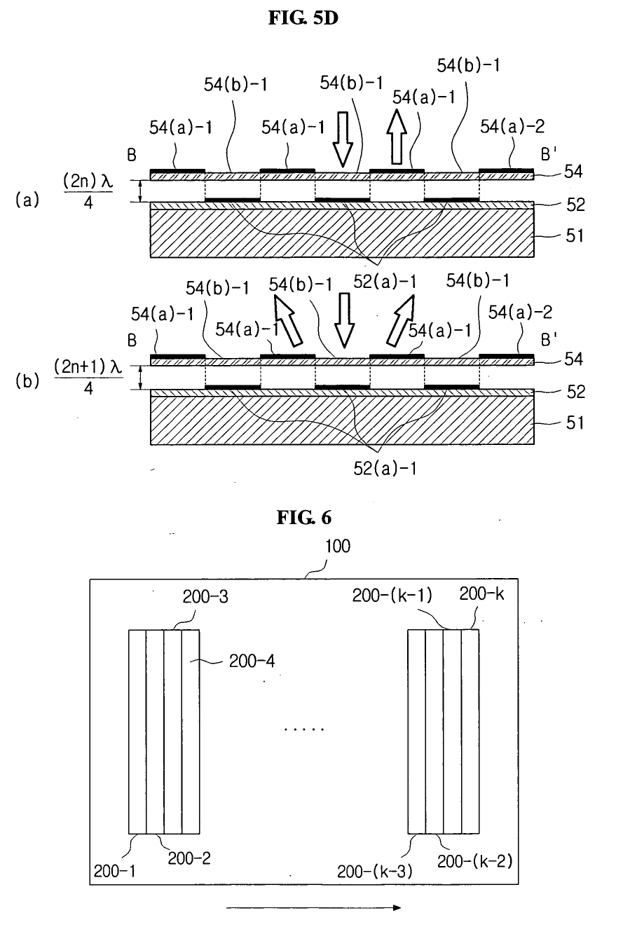

FIG. 5A is a perspective view of a diffraction type optical modulator element using piezoelectric elements, one of indirect type optical modulators applicable to embodiments of the present invention, and FIG. 5B is a perspective view of another diffraction type optical modulator element using piezoelectric elements applicable to embodiments of the present invention. In FIGS. 5A and 5B is illustrated an optical modulator comprising a substrate 51, an insulation layer 52, a sacrificial layer 53, a ribbon structure 54 and piezoelectric elements 55.

The substrate 51 is a commonly used semiconductor substrate, and the insulation layer 52 is deposited as an etch stop layer. The insulation layer 52 is formed of a material with a high selectivity to the etchant (the etchant is an etchant gas or an etchant solution) that etches the material used as the sacrificial layer. Here, reflective layers 52(a) and 52(b) may be formed on the insulation layer 52 to reflect incident light.

The sacrificial layer 53 upholds the ribbon structure 54 at both ends of the ribbon structure 54 to leave a gap between the ribbon structure 54 and the insulation layer 52, and forms a space in the center part.

As described above, the ribbon structure 54 modulates signals optically by creating diffraction and interference in the incident light. The ribbon structure 54 may be composed of a plurality of ribbon shapes according to the electrostatic type, and may have a plurality of open holes in the center part of the ribbons according to the piezoelectric type. The piezoelectric elements 55 control the ribbon structure 54 to move vertically according to the degree of up/down or left/right contraction or expansion generated by the voltage difference between the upper and lower electrodes. Here, the reflective layers 52(a) and 52(b) are formed in correspondence with holes 54(b) and 54(d) formed on the ribbon structure 54.

The descriptions below will focus on the type of optical modulator illustrated in FIG. 5A.

As shown in FIG. 5C, the optical modulator has an m number of micro-mirrors 50-1, 50-2, . . . , and 50-m, respectively responsible for pixel #1, pixel #2, . . . , and pixel #m. The optical modulator deals with image information with respect to one-dimensional images of vertical or horizontal scanning lines (here, it is assumed that a vertical or horizontal scanning line consists of an m number of pixels), and each micro-mirror 50-1, 50-2, . . . , 50-m deals with one of the m pixels constituting the vertical or horizontal scanning line. Accordingly, the light beam reflected and diffracted by each micro-mirror is later projected by an optical scanning device on a screen as a two-dimensional image. For instance, in the case of VGA 640*480 resolution, 480 vertical pixels are modulated 640 times on one surface of the optical scanning device (not shown in the accompanying drawings) so as to generate one frame per surface of the optical scanning device. Here, the optical scanning device may be a polygon mirror, a rotating bar, or a galvano mirror.

Below here, although the principle of optical modulation will be set forth with an example of the pixel #1, the following description can be applied to the other pixels in the same way.

In the present embodiment, it is assumed that two holes 54(b)-1 are formed in the ribbon structure 54. Due to the two holes 54(b)-1, there are three upper reflective layers 54(a)-1 formed on an upper part of the ribbon structure 54. On the insulation layer 52 are formed two lower reflective layers in correspondence with the two holes 54(b)-1. Besides, another lower reflective layer is formed on the insulation layer 52 in correspondence with a gap between the pixel #1 and the pixel #2. Consequently, the number of the upper reflective layers 54(a)-1 per pixel is the same as the number of the lower reflective layers, and the brightness of the modulated light can be controlled by using the modulated light (0th order diffracted light or ±1st order diffracted light).

FIG. 5D, a cross-sectional view along the line BB′ of FIG. 5C, explains a principle of optical modulation in a diffraction type optical modulator.

For example, in the case where the wavelength of the light equals λ, a first voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n)λ/4 (wherein n is a natural number). Accordingly, in the case of a zeroth (0th) order diffracted light (reflected light) beam, the overall path difference between the light reflected from the upper reflective layer 54(a), 54(c) formed on the ribbon structure 54 and the light reflected from the insulation layer 52 is equal to nλ, so that the modulated light has a maximum brightness due to a constructive interference. On the other hand, in the case of +1st and −1st order diffracted light, by which the brightness is at its minimum level due to a destructive interference.

A second voltage is applied to the piezoelectric elements 55 so that the gap between the upper reflective layer 54(a), 54(c) formed on the ribbon structure 54 and the insulation layer 52, where the lower reflective layer 52(a), 52(b) is formed, becomes equal to (2n+1)λ/4 (wherein n is a natural number). Accordingly, in the case of 0th-order diffracted light (reflected light) beam, the overall path difference between the light reflected from the upper reflective layer 54(a), 54(c) formed on the ribbon structure 54 and the light reflected from the insulation layer 52 equals to (2n+1)λ/2, so that the modulated light has its minimum brightness due to a destructive interference. However, in the case of +1st and −1st order diffracted light, the brightness is at its maximum level due to a constructive interference. As a result of such interference, the optical modulator can load signals on the light beam by regulating the quantity of the reflected or diffracted light.

Although the foregoing describes the cases in which the gap between the ribbon structure 54 and the insulation layer 52 on which the lower reflective layer 52(a), 52(b) is formed is equal to (2n)λ/4 or (2n+1)λ/4, it is obvious that a variety of embodiments, having the gap with which the intensity of light is controlled by diffraction and reflection, can be applied to the present invention.

FIG. 6 shows an image generated by a diffraction type optical modulator array applicable to embodiments of the present invention.

The light reflected and diffracted by an m number of vertically arranged micro-mirrors 50-1, 50-2, . . . , and 50-m is reflected from the optical scanning device, and then scanned horizontally on a screen 100, thereby generating images 200-1, 200-2, 200-3, 200-4, . . . , 200-(k−3), 200-(k−2), 200-(k−1), and 200-k. One image frame may be projected with one revolution of the optical scanning device. Although the scanning starts from the left to the right (the direction of the arrow), the scanning may also be performed in opposite direction.

In the present invention, an optical modulator element commonly refers to a device dealing with one dimensional image. The optical modulator element generates diffracted lights of diverse intensity by employing a GLV device 30, a MEMS structure, or the interference principal, thereby capable of loading diverse signals on the light.

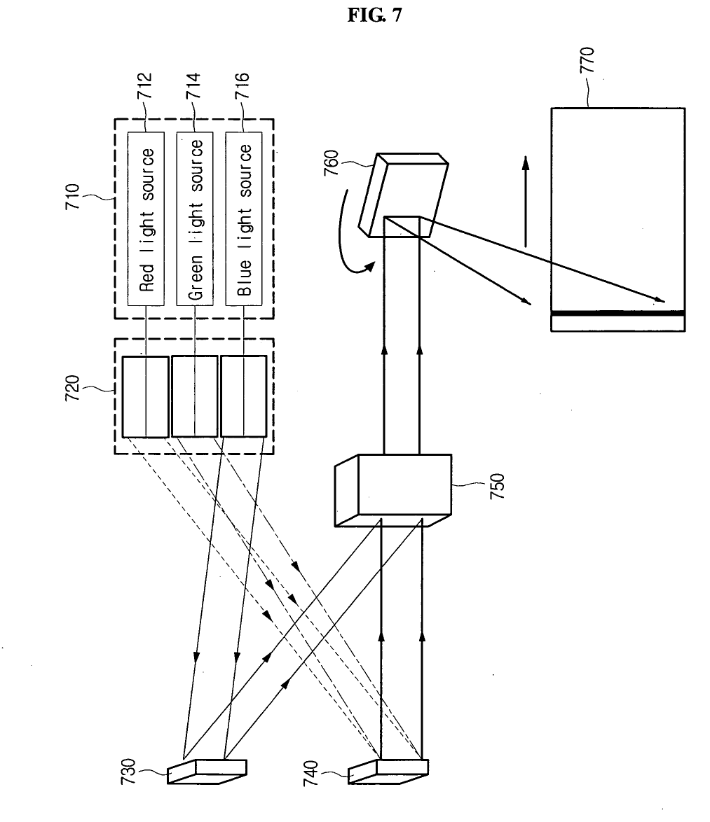

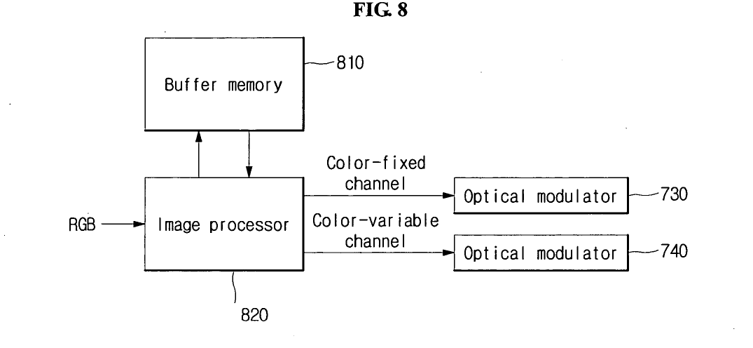

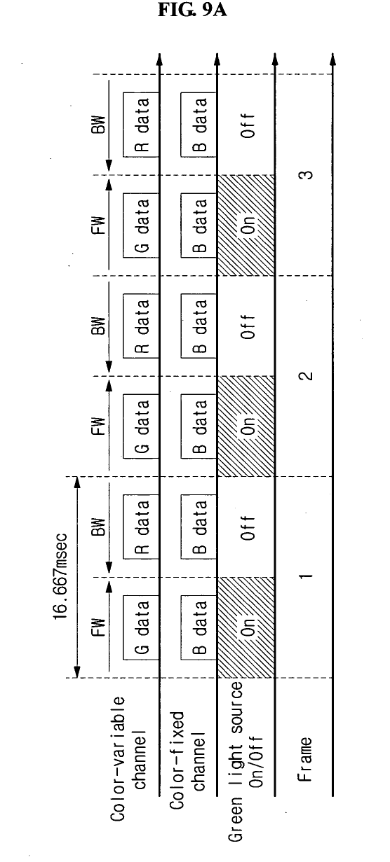

FIG. 7 illustrates a schematic configuration of a two panel type color display device according to an embodiment of the present invention, and FIG. 8 illustrates a driving circuit driving a color-fixed panel and a color-variable panel.

As shown in FIG. 7, a two panel type color display device comprises a light source part 710, an optical illumination part 720, a color-fixed panel 730, a color-variable panel 740, a color synthesizing part 750, a projection system 760 and a screen 770.

The light source part 710 consists of a plurality of light sources, each of which is composed of a red light source 712, a green light source 714, and a blue light source 716, which are the three primary colors of light. Each color light from the light source part 710 is incident on the color-fixed panel 730 and the color-variable panel 740 via the optical illumination part 720.

The color-fixed panel 730 receives a fixed color light from one of the red, green, and blue color light sources 712, 714 and 716, and preferably from the one having relatively a low power output. The fixed color may be red, green, or blue.

The other two color lights, exclusive of the fixed color, are sequentially incident on the color-variable panel 740, as first and second variable color lights. In the case that the red color light is the fixed color light, the green and blue lights are variable color lights. In the case that the green color light is the fixed color light, the red and blue lights are variable color lights. In case the blue color light is the fixed color light, the red and green lights are variable color lights.

The first and second variable color lights are incident on the color-variable panel 740 not simultaneously but sequentially, the second variable color light after the first variable color with a time interval. The light sources corresponding to the first or second variable colors are turned on or off according to the order. Otherwise, a color wheel, through which only the first and second variable color lights in the light beam concentrated with the first and second variable color lights pass in sequence, can be used so that only one of the two variable color lights is incident on the color-variable panel 740.

When the first variable color light is incident, the color-variable panel 740 is provided with a control signal (first color image information) corresponding to the first variable color light so that the first variable color light is modulated. In the same way, when the second variable color light is incident, the color-variable panel 740 is provided with a control signal (second color image information) corresponding to the second variable color light so that the second variable color light is modulated. Such control signals are supplied from an image processor 820, which will be described later on.

The color-fixed panel 730 and the color-variable panel 740 each comprise an optical modulator element, and generate diffracted lights by modulating the intensity of incident light according to the control signals.

The fixed color light is incident on the color-fixed panel 730, and then the diffracted fixed color light is sent to the color synthesizing part 750.

The first and/or second variable color lights are incident on the color-variable panel 740, and then the diffracted first and/or second variable color lights, generated by modulating the first and/or second variable color lights, are incident to the color synthesizing part 750.

The color synthesizing part 750 combines the modulated fixed color light and the first and/or second modulated variable color lights, thereby generating a synthesized signal.

The projection system 760 comprises a scanner (not shown in the accompanying drawings) and a projection lens (not shown in the accompanying drawings). The scanner scans the synthesized signal to the space in synchronization with the image signals (fixed color image information, first or second variable color image information). The projection lens projects the synthesized signal scanned to the space on the screen 770 as a color image.

The synthesized signal in the projection system 760, as a one-dimensional signal, may be an image signal with respect to one of vertical or horizontal lines of one frame. Although the following will focus on a vertical line, this shall not limit the scope of the present invention.

The optical modulator element modulating the intensity of the incident light in the color-fixed panel 730 or the color-variable panel 740 has a number of micro-mirrors corresponding to the number of pixels of the vertical line. The micro-mirror, each responsible for one pixel, modulates the intensity of the light. A plurality of micro-mirrors are disposed in parallel to form an optical modulator element, and generates diffracted light, the image signal corresponding to one vertical line by modulating the incident light. (Refer to FIGS. 3, 5A, and 5B.)

The image signal corresponding to one vertical line is sent to the projection system 760, and then is projected, through the scanner rotatable in a predetermined direction or from side to side, to the vertical line positioned on the screen in correspondence with the image signal. After all the image signals of the vertical lines are projected in a horizontal direction by the rotation of the scanner, one frame, perceived as one picture to human eyes, is obtained.

In the present invention, the signals inputted to the color synthesizing part 750 in a certain moment are the modulated fixed color light and either the first or second variable color light. Since the color-variable panel 740 can modulate one variable color at a time, both the first and second modulated variable colors cannot be inputted to the color synthesizing part 750 at the same time. Accordingly, among the three colors of light, one modulated fixed color and either the first or second modulated variable colors are combined by the color synthesizing part 750.

However, this is not enough to produce a perfect color image because the other variable color has not been combined. Therefore, after the projection system 760 projects a color image by scanning the screen 770 in a predetermined direction during one period, the other modulated variable color light, which was not combined in the previous period, is combined with the modulated fixed color light in the next period.

Human eyes perceive a picture changing more rapidly than predetermined frequency as a successive picture not as a static picture. Therefore, the frequency of the process during which the projection system 760 projects the signal, a composition of the modulated fixed color light and the second modulated variable color light, onto the screen, after projecting the signal, a composition of the modulated fixed color light and the first modulated variable color light, should be higher than the predetermined frequency.

There are mainly two methods in use for television broadcasting, NTSC (national television system committee) and PAL (phase alternation by line).

In the NTSC method, red, green and blue signals are matrix transformed to one luminance signal (Y) and two chrominance signals (I, Q), and then transmitted with a bandwidth of 6 MHz. The PAL method improved the drawback of the NTSC in the color transmission.

While the NTSC has 525 scanning lines and a 60 Hz of field frequency, PAL has 625 scanning lines and a 50 Hz of field frequency.

When the primary colors are projected to one picture according to the field frequency, human eyes have an illusion that the picture is being formed simultaneously.

Consequently, it is preferable that the frequency of the scanner of the projection system 760 is 2n (n is a natural number) times as high as the field frequency (in the case of NTSC:60 Hz, in the case of PAL:50 Hz). Accordingly, when one field is composed, the scanning is performed 2n times in the predetermined direction so that the modulated first and second variable color lights are projected in one field on the screen 770.

The modulated fixed color light may have a lower power output than the first or second modulated color lights, because the modulated fixed color light is projected onto the screen 770 twice as frequently as the first or second modulated color lights. That means the light source having a lower output can be chosen as a fixed color light source, and the other two are assigned for variable color light sources.

In FIG. 8 are illustrated a buffer memory 810 and an image processor 820 employed for modulating the intensity of the incident light in the color-fixed panel 730 and the color-variable panel 740.

The buffer memory 810 stores all RGB information corresponding to one frame. Here, the RGB information refers to information regarding the intensity of red, green, and blue colors of pixels in a number of (the number of vertical line pixels)×(the number of horizontal line pixels) which constitute one frame on the screen 770

The image processor 820 accesses the RGB information stored in the buffer memory 810 and extracts fixed color image information therefrom, followed by transmitting the fixed color image information to the color-fixed panel 730 through a fixed color channel. Also, the image processor 820 accesses the RGB information and extracts variable color image information therefrom, followed by transmitting the variable color image information to the color-variable panel 730 through a variable color channel. The fixed or variable color image information contain light intensity information regarding a single vertical line in order to modulate the fixed and variable color lights incident on each panel.

On the color-variable panel 740 are incident the first and second variable color lights sequentially. Accordingly, the image processor 820 likewise extracts the information regarding the intensity of the first and second variable colors in synchronization with the incident variable color lights, and delivers the information to the color-variable panel 740 sequentially.

The scanner operates 2n times during the time corresponding to one frame, during which the fixed color is outputted 2n times as frequently as the variable color.

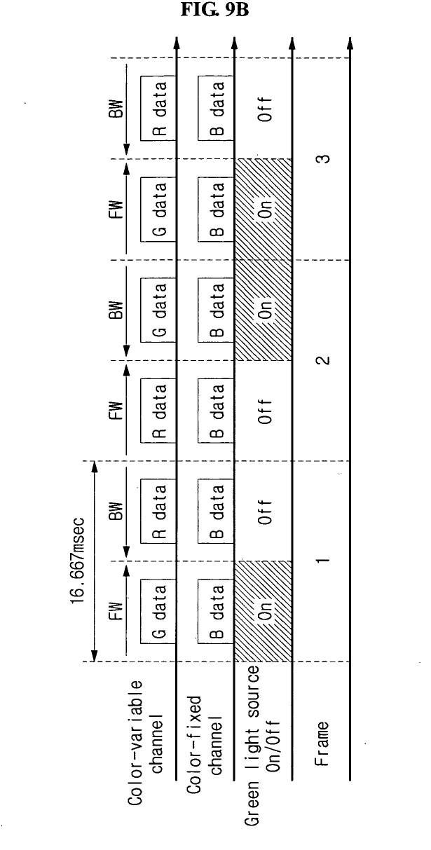

FIGS. 9A and 9B show exemplary image information delivered from the image processor 820 to each panel with the passage of time in accordance with an embodiment of the present invention. The following example is described on the assumption that the blue is fixed color, and the red and green are variable colors, which shall not limit the scope of the present invention. Based on the NTSC method, the field frequency is 60 Hz, and the period of one frame is 16.667 ms.

Referring to FIG. 9A, during a first frame is delivered image information regarding the blue to the color-fixed channel twice, in succession. On the other hand, to the color-variable channel are each delivered information regarding the green and red once each, sequentially. The green light source is turned on during the first half, and turned off during the later half. Conversely, the red light source is turned off during the first half, and turned on during the later half.

In the same way, image information is regularly delivered through fixed and variable color channels to second and third frames. However, each frame receives different image information.

Referring to FIG. 9B, during the first frame is delivered image information regarding the blue to the color-fixed channel twice, in succession. On the other hand, to the color-variable channel are each delivered information regarding the green and red once each, sequentially. The green light source is turned on during the first half, and turned off during the later half. Conversely, the red light source is turned off during the first half, and turned on during the later half.

During a subsequent second frame, image information regarding the blue is delivered to the color-fixed channel in the same way, twice in succession. However, image information regarding the red is first delivered, and information regarding the green later.

More specifically, through the color-variable channel, the image information is converted from G-R-G-R . . . (see FIG. 9A) to G-R-R-G-G-R . . . (see FIG. 9B). In the case of FIG. 9A, the on/off frequency of variable color light source (red and green light sources) should be 60 Hz, the same as the field frequency. However, in the case of FIG. 9B, the on/off frequency of variable color light source may be 30 Hz, half of the field frequency. As a result, the life span of the light source device can be increased.

Here, the image processor 820 extracts the image information regarding the fixed and variable colors from the RGB information sequentially, along a predetermined direction of the vertical lines, in which direction the scanner operates its scanning. For example, in case that the number of pixels of a horizontal line is k (k is a natural number), which means the number of vertical lines is also k, the image processor 820 extracts the image information regarding the fixed and the first variable colors from first through kth vertical lines sequentially during the first frame (namely, the first half period), and extracts the image information regarding the fixed and the first variable colors from first through kth vertical lines sequentially during the second frame (namely, the second half period). Here, one period consists of the first and second frames.

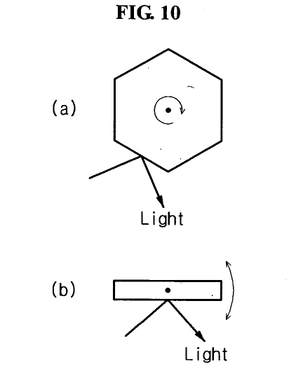

FIGS. 10(a) and 10(b) illustrate variable embodiments of a scanner used in the present invention.

Referring to FIG. 10(a), the scanner may be a polygon mirror. The polygon mirror has a polygonal prism shape, and has mirrors attached to its sides. The polygon mirror rotates around an axis in a consistent direction, by which the mirror attached to the side causes the angle of reflection of the incident light to change before projected onto the screen 770.

Here, to generate a picture corresponding to one frame on the screen 770, the polygon mirror rotates in a predetermined direction during the first half period, and returns to its starting position to rotate again with the predetermined direction during the second half period. Through this, both the first and second variable colors can be projected onto the screen 770 during one period. In other words, the scan frequency preferably equals to (2n times the field frequency according to the television broadcasting method)/(the number of the sides of the polygonal prism). The following will explain the reason: The scan frequency should be at least twice as high as the field frequency according to the television broadcasting method to project the images generated by the first and second variable colors onto the screen 770. Every each side of the polygonal prism has a mirror, so that scanning is performed as many times as the number of sides of the polygonal prism during one rotation of the polygon mirror. Therefore, the scan frequency equals to (2n times the field frequency according to a television broadcasting method)/(the number of the sides of the polygonal prism).

Referring to FIG. 10(b), the scanner may be a galvano mirror. The galvano mirror has a tetragonal board shape, and has a mirror on its side, and rotates around an axis from side to side within a predetermined angular range. In the present invention, the galvano mirror changes the angle of reflection of the incident light only when rotating in a certain direction before projected onto the screen 770.

The galvano mirror rotates in a predetermined direction during the first half period to generate one picture corresponding to one frame on the screen 770, and, during the second half period, returns to the starting position before rotating in the predetermined direction again. Through this, both the first and second variable colors can be projected onto the screen 770 during one period. Such rotation frequency is called a scan frequency, which should be 2n times as high as the field frequency.

Or the galvano mirror rotates bi-directionally during one period to generate one picture corresponding to one frame on the screen 770. During the first half period, the galvano mirror rotates in a first direction, and in an direction opposite to the first direction during the second half period, through this, both the first and second variable colors can be projected onto the screen 770 during one period. Such rotation frequency is called a scan frequency, which should be 2n times as high as the field frequency.

While the invention has been described with reference to the disclosed embodiments, it is to be appreciated that those skilled in the art can change or modify the embodiments without departing from the scope and spirit of the invention or its equivalents as stated below in the claims.

The embodiments of the invention in which an exclusive property or privilege is claimed are defined as follows:

1. A two panel type color display device comprising:
a buffer memory storing RGB information corresponding to one frame—wherein, the RGB information contains the intensity of red, green, and blue colors of (the number of vertical line pixels)×(the number of horizontal line pixels) pixels constituting one frame—;
an image processor accessing the RGB information stored in the buffer memory and extracting therefrom fixed color image information corresponding to a fixed color light and a plurality of variable color image information corresponding to a plurality of variable color lights;
a color-fixed panel modulating the fixed color light according to the fixed color image information and outputting the modulated fixed color light;
a color-variable panel modulating the corresponding variable color lights according to the plurality of variable color image information and outputting the modulated variable color lights sequentially;
a fixed color light source providing the fixed color light to the color-fixed panel;
a plurality of variable color light sources providing the variable color lights to the color-variable panel;
a color synthesizing part generating a synthesized signal combined the modulated fixed and variable color lights; and
a projection part scanning the synthesized signal in a predetermined direction on a screen.

2. The two panel type color display device of claim 1, wherein the color-fixed and color-variable panels each comprise an optical modulator element outputting a diffracted light generated by modulating incident light according to control signals, wherein the control signals are the fixed color and variable color image information, and the incident light consists of the fixed and variable color lights, and the diffracted light consists of the modulated fixed and variable color lights.

3. The two panel type color display device of claim 1, wherein the fixed color image information, the variable color image information, and the synthesized signal represent one line that is a one dimensional image displayed on a screen, and are implemented as a two dimensional image by being scanned in a direction perpendicular to the one line in the projection part.

4. The two panel type color display device of claim 3, wherein the fixed color image information, the variable color image information, and the synthesized signal represent one vertical line that is one a dimensional image displayed on a screen, and are implemented as a two dimensional image by being scanned in a horizontal direction in the projection part.

5. The two panel type color display device of claim 3, wherein the fixed color image information, the variable color image information, the synthesized signal represent one horizontal line that is a one dimensional image displayed on a screen, and are implemented as a two dimensional image by being scanned in a vertical direction in the projection part.

6. The two panel type color display device of claim 1, wherein one of red, green, and blue lights is the fixed color light, and the other two are the variable color lights.

7. The two panel type color display device of claim 1, wherein in the case that one of the plurality of variable color light sources is turned on, the rest of the variable color light sources are turned off.

8. The two panel type color display device of claim 7, wherein the fixed color image information contains the intensity of the variable color light corresponding to the turned on variable color light source.

9. The two panel type color display device of claim 1, wherein the projection part comprises a scanner converting the synthesized signal of one dimensional image to a two dimensional image on the screen.

10. The two panel type color display device of claim 9, wherein the scanner is a polygon mirror having a polygonal prism shape, the scan frequency is equal to (2n times the field frequency according to a television broadcasting method (n is a natural number))/(the number of the sides of the polygonal prism)

11. The two panel type color display device of claim 9, wherein the scanner is a galvano mirror, and the scan frequency is equal to 2n times the field frequency according to a television broadcasting method (n is a natural number).

12. The two panel type color display device of claim 10, wherein the fixed color light source keeps turned on, while the variable color light source is repeatedly turned on or off sequentially according to the scan frequency.

13. The two panel type color display device of claim 11, wherein the fixed color light source keeps turned on, while the variable color light source is repeatedly turned on or off according to the scan frequency.

14. The two panel type color display device of claim 1, the image processor delivers the fixed color image information to the color fixed panel twice during one frame time, and delivers the plurality of variable color image information to the color variable panel sequentially one by one.

15. The two panel type color display device of claim 14, wherein the variable color light source responds to the variable color image information delivered from the image processor, thereby repeatedly turned on or off sequentially.
